(19) United States
(12) Patent Application Publication
(10) Pub. No.: US 2002/0117857 A1
(43) Pub. Date: Aug. 29, 2002

(54) Diesel-electric regenerative hydro power cell

(76) Inventor: Donald B. Eckstein, Annandale, VA (US)

Correspondence Address: Robert M. Downey, ROBERT M. DOWNEY, P.A., Suite 350, 150 E. Palmetto Park Road, Boca Raton, FL, 33432, US

(21) Appl. No.: 09/792,830

(22) Filed: Feb. 23, 2001

(51) Int. Cl. B60L 1/02; F02C 6/00; F02C 6/18; F01K 15/00; F01K 17/02

(52) U.S. Cl. 290/2; 290/40 C

(57) ABSTRACT

An electrical energy storage and regeneration system uses the electricity generated by the dynamic brakes of a diesel-electric locomotive to convert water into hydrogen gas and oxygen gas by hydro-electrolysis. The gases are compressed, cooled and stored in tanks for subsequent use to supply fuel cells. Electricity generated by an electro-chemical reaction in the fuel cells is used to power the locomotive traction motors when needed. Alternatively, the regenerated electricity can be used to supplement a local or regional power supply, particularly in times of shortage. The water by-product from the fuel cell electricity generation is collected and stored for use in hydro-electrolysis during a subsequent power storage/regeneration cycle. In a preferred embodiment, the system, defining a hydro power cell, includes a water storage tank, a hydro-electrolysis unit, low pressure compressors, fuel cells, oxygen concentrators, DC/AC inverters, and electrical controllers all contained on a designated railroad car connected directly behind a multi-unit locomotive consist. The hydrogen and oxygen gas storage tanks, as well as high pressure compressors, may be carried on the same train car or a separate car.

### BACKGROUND OF THE INVENTION

1. Field of the Invention

This invention relates to a system for storage and regeneration of electricity and, more particularly, to a hydro power cell which stores and regenerates electricity created by dynamic and friction braking of a prime mover, such as a diesel-electric locomotive. The hydro power cell converts the electric energy created by the locomotive brakes into hydrogen gas and oxygen gas by hydro-electrolysis. Fuel cells are used to regenerate electricity from the energy of the gases.

2. Discussion of the Related Art

Diesel-electric locomotives have been used for switching, passenger, and long haul freight service for over 60 years. Switching and passenger trains are of limited size and weight due to the nature of their use. For instance, switching trains are used in switching yards to build long haul freight trains and, therefore, they are not required to pull heavy loads for long distances. Passenger locomotives, weighing approximately 800 tons, need to be able to sprint from a standing start to high speed, and to come to a halt in a smooth and uninterrupted manner. Freight locomotives, on the other hand, need tremendous power for pulling heavy loads, particularly when climbing long grades through mountainous terrain. Freight trains typically weigh 7000 or more tons and require multiple locomotives (“lash-ups” or “consists”), with the lead locomotive (engineer) controlling the other engines. Very heavy freight trains might have 4-6 locomotives pulling the train, with another 2-3 units in the rear pushing in locations with steep grades.

The well-proven design of the diesel-electric locomotive uses a diesel engine connected to a generator (DC) or an alternator (AC) to drive direct current (DC) electric traction motors mounted in the locomotive's axle trucks. The truck assembly includes the wheels and axles, with a traction motor attached to each axle. The truck frame assembly attaches to a bolster with a suspension, including springs, pads, swing hangers, or a combination of those components which serve to provide a smooth ride. The bolster attaches to the frame of the locomotive and is held in place by gravity. Massive electrical cables provide power to the traction motors and air lines deliver pressurized air for operating the pneumatic brakes of the locomotive.

Older locomotives, manufactured in the 1980's and earlier, have horsepower ratings of between 2,000-4,000 HP and use DC traction motors. In the 1990's, General Motors Electro-Motive Division (EMD) and General Electric (GE), the two remaining U.S. manufacturers in the industry, began incorporating more efficient (and expensive) AC traction motors on their 4,000 horsepower class locomotives, replacing DC motor technology that had been the locomotive standard for over 100 years. Later in the decade, the horsepower race took another major leap forward when EMD introduced the SD90MAC locomotive and GE introduced the AC6000 locomotive, both of which provide 6000 horsepower with AC traction motors to provide unprecedented pulling power.

In theory, AC traction drive is more efficient and has greater potential performance than DC. In practice, this advantage could not be effectively realized until the late 1990's when the advanced electronics and microprocessors needed to control AC traction motors were refined and made reliable. The increased horsepower and pulling power of the new SD90MAC and AC6000 locomotives allows the replacement of older locomotives on a 2:3 or even a 1:2 ratio. These replacement ratios significantly reduce operations and maintenance costs, while allowing the older locomotives they replace to be used in less demanding switch yard or local freight rolls.

Diesel-electric locomotives use both air actuated pneumatic friction brakes and dynamic brakes, either individually or in conjunction, to stop the locomotive or to control the speed of the locomotive when traveling down a long grade. Air brakes, which have remained essentially unchanged since the steam era, are designed to hold the friction brakes away from the wheels when pressurized so that any loss of air pressure would stop the train in the event of a malfunction. Dynamic brakes provide a more cost-effective braking system and take advantage of the fact that electric motors can also generate electricity. When applied, the dynamic brakes turn the traction motors into generators. As the speed and momentum of the train acts against the resistance of the magnetic fields of the motors, the work that is used to slow the train generates the electricity. The generated electricity is shunted to resistance grids, where the electricity is turned into heat and ventilated (dissipated) through exterior vents on the hood of the locomotive. Dynamic brakes actually supplement, rather than replace, the independent air brakes and are typically most effective at around 10-25 mph. The dynamic braking system can be used thousands of times with little or no maintenance, while train air brakes require daily visual testing and incur significant maintenance, man hours and replacement costs. Thus, use of the dynamic brakes helps to save significant wear and tear on each locomotive's or train car's air/friction braking system.

The fact that the latest diesel-electric locomotives have 4,000-6,000 horsepower diesels and equivalent rated electric traction motors installed to generate forward pull, while using the same traction motors to dissipate this forward motion during dynamic braking, is grossly inefficient and represents a tremendous economic and hydrocarbon emissions reduction opportunity. The amount of energy wasted in this process per annum in the U.S. alone may easily amount to hundreds of megawatt of energy, and possibly well into the gig watt hour range. The simple reason for this wastage is that there is no currently known or available electric storage medium that can efficiently or effectively store the tremendous amounts of kinetic/electric energy routinely generated and dissipated by a typical modern freight train (i.e., four to six locomotives with 10-25,000 horsepower pulling 5-10,000 tons).

### SUMMARY OF THE INVENTION

The present invention provides a diesel-electric regenerative hydro power cell which uses two proven and uniquely complimentary electro-chemical conversion techniques to store and regenerate the tremendous amounts of electricity created by the dynamic brakes of diesel-electric locomotives which is currently being dissipated as heat. Specifically, the hydro power cell of the present invention uses hydro-electrolysis to convert the energy of electricity into hydrogen and oxygen gas. The hydrogen and oxygen gas is pressurized and stored and is subsequently used to supply fuel cells which create electricity via a chemical interaction with these two elements, with the only by-product being water and heat. The chemical theory and practical applications of water electrolysis and fuel cells are well known to technical specialists skilled in the subject matter areas. In combining these two processes, the present invention takes advantage of the large amounts of electricity generated by the dynamic brakes of the diesel-electric locomotive and the extremely high efficiency in regenerating electricity using fuel cells. Thus, water electrolysis and fuel cells are combined in a cycle of breaking water into its two gaseous elements (i.e., hydrogen and oxygen) and changing these elements back into electricity and water.

The diesel-electric regenerative hydro power cell of the present invention uses a hydro-electrolysis unit to convert the energy of the large amounts of excess electricity routinely generated by dynamic braking of the locomotive into hydrogen gas and oxygen gas. The oxygen and hydrogen gases produced are compressed and stored in tank cars until needed. When additional power is required, the stored oxygen and hydrogen gases are used to supply fuel cells. The electricity generated by the fuel cells is then used to power the locomotive traction motors, and the water product (from fuel cell electricity generation) is collected and stored until the cycle starts again.

### Objects and Advantages of the Present Invention

With the foregoing in mind, it is a primary object of the present invention to provide a diesel-electric regenerative hydro power cell for efficiently and effectively storing and regenerating the tremendous amounts of kinetic/electric energy routinely generated and dissipated by a typical freight train pulled by one or more diesel-electric locomotives.

It is a further object of the present invention to provide a diesel-electric regenerative hydro power cell which stores and regenerates the tremendous amount of electricity created by the dynamic brakes of a freight train with nearly 100% efficiency.

It is still a further object of the present invention to provide a regenerative hydro power cell for storing and regenerating electricity in a manner which avoids the release of hydrocarbons and other pollutants.

It is still a further object of the present invention to provide a regenerative hydro power cell for storing and regenerating tremendous amounts of electricity which uses hydro-electrolysis and fuel cells in combination, in a closed system, to convert excess electricity and water into hydrogen and oxygen components and back into electricity with almost 100% efficiency.

It is still a further object of the present invention to provide a regenerative hydro power cell which can be used for mobile auxiliary power generation, with a significant inherent output surge capacity.

It is still a further object of the present invention to provide a hydro power cell which can generate hydrogen and oxygen for industrial uses at a lesser cost then current traditional electro-chemical methods.

It is still a further object of the present invention to provide a hydro power cell which can be used to power locomotives in an electric-only, noise and pollution-free mode for significant distances or time periods, using the electric power stored and regenerated by the hydro power cell, thereby reducing fuel consumption and lowering the cost of locomotive operation.

It is still a further object of the present invention to provide a diesel-electric regenerative hydro power cell which significantly extends the productive life of existing diesel-electric locomotives by maximizing the use of their traction motors and minimizing the use of diesel engines.

It is still a further object of the present invention to provide a diesel-electric regenerative hydro power cell which significantly extends the productive life of train friction braking systems by using additional dynamic braking to maximize electrolysis-fuel cell power generation.

It is still a further object of the present invention to provide a diesel-electric regenerative hydro power cell which can be incorporated into older model locomotives in a manner which permits the older locomotives to use the greatest horsepower/amperage rated traction motors available, to thereby increase the pulling/dynamic braking power of the locomotive by a factor of 2-3 as compared to use of traction motors which are matched to the originally installed diesel output rating.

It is still a further object of the present invention to provide a diesel-electric regenerative hydro power cell which minimizes the use of moving parts, thereby increasing efficiency and reducing maintenance costs.

These and other objects and advantages of the present invention are more readily apparent with reference to the detailed description which follows.

### BRIEF DESCRIPTION OF THE DRAWINGS

For a fuller understanding of the nature of the present invention, reference should be made to the following detailed description taken in conjunction with the accompanying drawings in which:

FIG. 1 is a functional block diagram of the major components of a diesel-electric locomotive system using the diesel-electric regenerative hydro power cell of the present invention;

FIG. 2 is a functional block diagram of the diesel-electric regenerative hydro power cell components; and

FIG. 3 is a functional block diagram of a multiple unit diesel-electric locomotive consist shown connected with the regenerative hydro power cell unit and hydrogen and oxygen gas tank storage cars of the invention.

Like reference numerals refer to like parts throughout the several views of the drawings.

### DETAILED DESCRIPTION OF THE PREFERRED EMBODIMENT

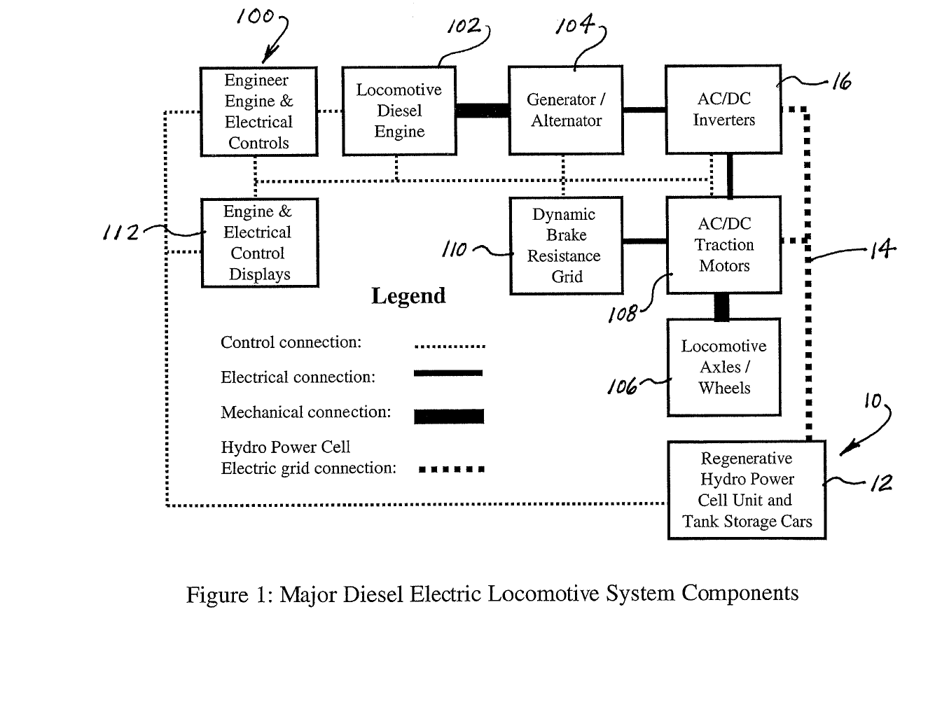

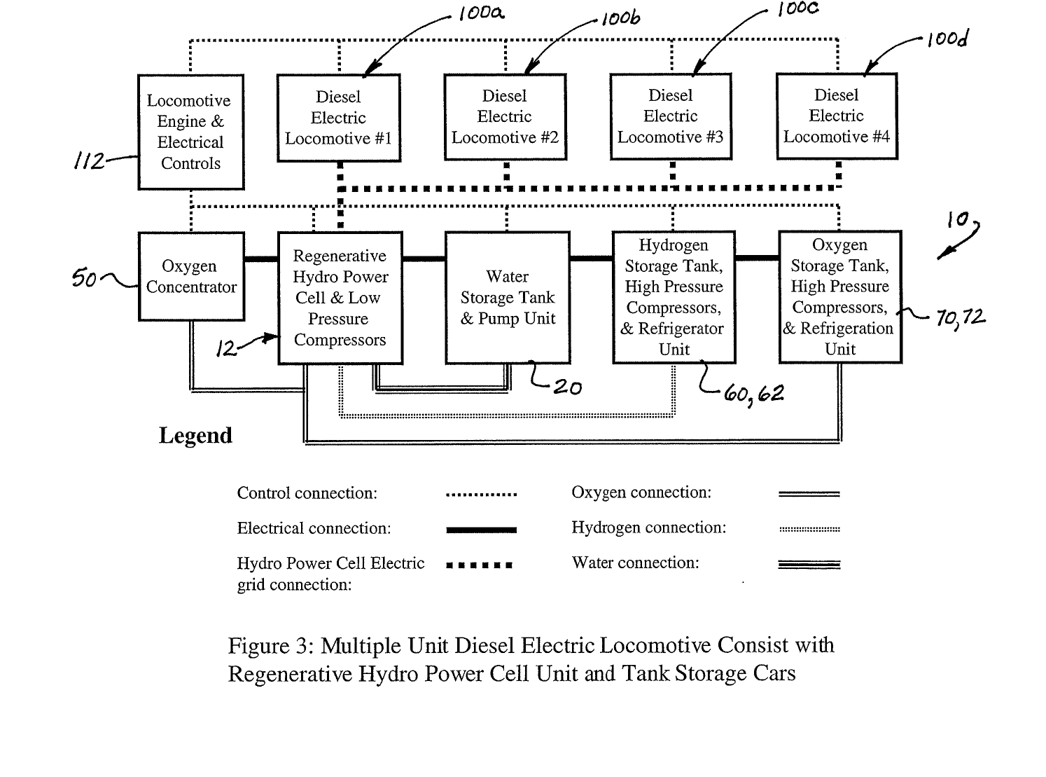

Referring to FIGS. 1-3, the regenerative hydro power cell system 10 of the present invention is shown in conjunction with one or more diesel-electric locomotives 100 and a train in accordance with a preferred embodiment of the invention.

The conventional diesel-electric locomotive design includes a diesel engine 102 which powers a generator (DC) or alternator (AC) 104 for supplying electric power to traction motors 108. The traction motors drive the wheels 106 and provide dynamic braking. The conventional design routes all of the regenerated power from the traction motors 108 directly to the locomotive's dynamic brake resistance grid 110. The electricity is converted to heat in these large toaster-like grids and the converted heat is blown out of vents at the top of the locomotive. The present invention modifies this conventional design and routes the regenerated power to a regenerative hydro power cell electric grid 14 which consists of each diesel-electric locomotive in a multiple unit consist being electrically connected to each other and to the hydro power cell (HPC) unit 12 of the invention. In a preferred embodiment, the HPC unit 12 is incorporated on an independent railroad car which is connected directly behind a multiple unit locomotive consist of a freight train or even a passenger train.

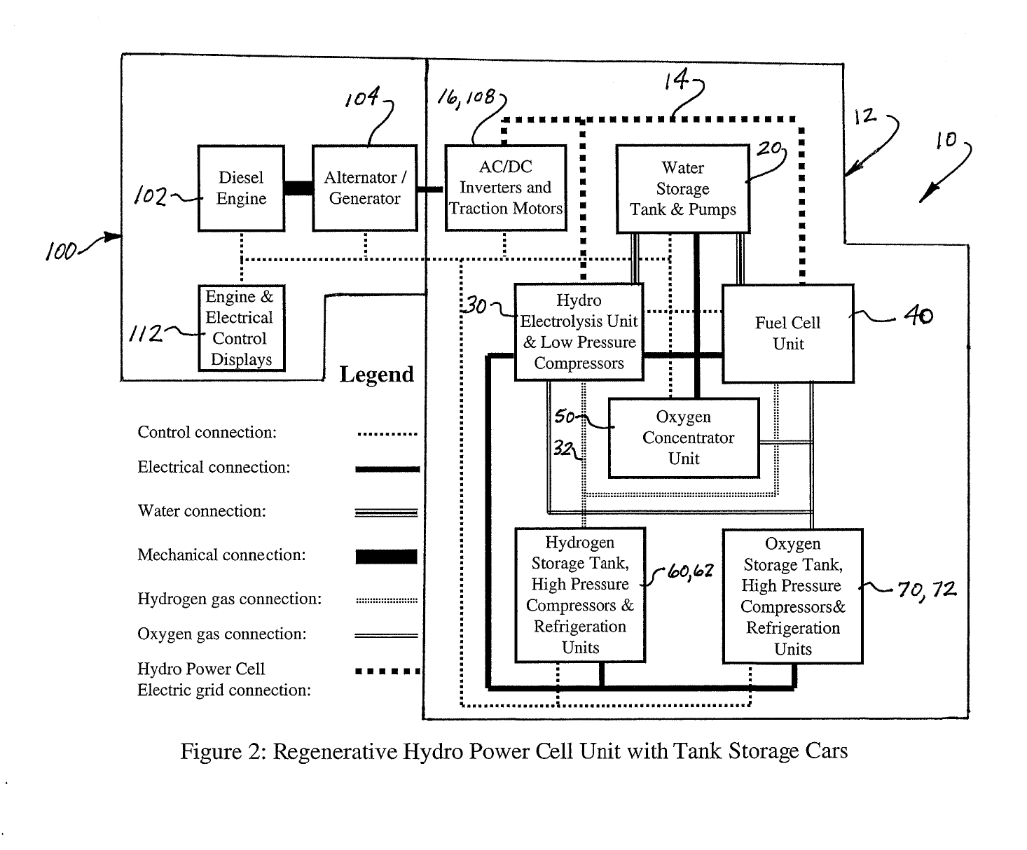

Referring to FIG. 2, the HPC unit 12 includes a water storage tank 20, a hydro-electrolysis unit 30, a fuel cell unit 40, and an oxygen concentrator unit 50. Hydrogen storage tanks 60 with high pressure compressor 62 and oxygen storage tanks 70 with high pressure compressor 72 may be carried on the same car or a separate car.

In operation, electric power from the locomotive consist feeds the hydro-electrolysis unit 30 in the HPC 12. When powered, the hydro-electrolysis unit 30 generates oxygen gas and hydrogen gas. These gases are removed from the hydro-electrolysis unit by low pressure compressors. The low pressure oxygen and hydrogen gases are then sent via pipes 32 to the respective hydrogen and oxygen storage tanks 60, 70. High pressure compressors 62, 72 are provided to fill the hydrogen and oxygen storage tanks which are insulated using a thermos type design. Prior to entering the tanks, the high pressure gases are routed through refrigerator units for cooling, thereby significantly increasing the amount of gas that can be stored in the tanks 60, 70. Water which condenses on the cooling coils in the refrigerator units is collected and routed back to the HPC unit 12 where it is stored in the water storage tank(s) 20 for future use in a subsequent power storage/regeneration cycle.

Once the pressure in the low pressure oxygen and hydrogen transfer pipes 32 reaches a predetermined level, the high pressure compressors and tank car refrigerators, which are powered by the regenerative power grid, turn on. The low pressure oxygen and hydrogen pipes allow multiple storage tank cars to be connected to the HPC unit 12. The HPC unit 12 is sized so that it has the capacity to handle 10-25,000 horsepower worth of regenerated electricity. This is enough capacity to handle the regenerative dynamic output of the maximum number of locomotives that would normally pull a given heavy freight train. This capacity is also sufficient to generate (via the fuel cells) the maximum amount of electric output that the locomotive's electric traction motors could normally handle. The number of hydrogen and oxygen storage tanks, and accordingly, the number of tank cars, can be varied according to the storage capacity needed.

When the oxygen and hydrogen is needed to supply the fuel cells in the fuel cell unit 40, the electronics controller sends a signal to release each gas from the appropriate tanks so that the pressure in the low pressure pipes 32 is maintained at a certain level. The gas (i.e., hydrogen and oxygen) from these pipes is fed to the fuel cells to generate electricity. Since fuel cells generate DC current, inverters 16 are provided to match the HPC unit electric output to the requirements of AC locomotives, when needed.

It may be necessary to increase the amount of oxygen available to the fuel cells so that the oxygen is provided in the same proportion as the hydrogen generated by hydro-electrolysis. This avoids a situation where there is excess hydrogen gas due to the lower amounts of oxygen which are generated by hydro-electrolysis (i.e., 2 parts hydrogen for 1 part oxygen). To produce additional oxygen, when needed, an oxygen concentrator unit 50 is provided. The oxygen concentrator unit may comprise one or a plurality of oxygen concentrators which use a compressor to push atmospheric air through a permeable membrane. The oxygen concentrators then separate the oxygen from nitrogen and trace gases in atmospheric air. The produced oxygen from the oxygen concentrators can then be used to supplement the oxygen gas supply which is fed to the fuel cells.

The fuel cell unit 40 consists of one or more fuel cells, as mentioned above. Each fuel cell consists of a power section, where the chemical reaction occurs, and an accessory section that controls and monitors the power section's performance. The power section, where hydrogen gas and oxygen gas are transformed into electrical power, water and heat, consists of a plurality of cells contained in several sub-stacks. Manifolds run the length of each of the sub-stacks and distribute the hydrogen gas, oxygen gas, and coolant to the cells. The cells contain electrolyte consisting of potassium hydroxide and water, an oxygen electrode (cathode) and a hydrogen electrode (anode). The accessory section monitors the reactant flow, removes waste heat and water from the chemical reaction, and controls the temperature of the stack. The accessory section consists of the hydrogen and oxygen flow system, the coolant loop, and the electrical control unit. In operation, oxygen is routed to the fuel cell's oxygen electrode, where it reacts with the water and returning electrons to produce hydroxyl ions. The hydroxyl ions then migrate to the hydrogen electrode, where they enter into the hydrogen reaction. Hydrogen is routed to the fuel cells hydrogen electrode, where it reacts with the hydroxyl ions from the electrolyte. This electro-chemical reaction produces electrons (electricity), water and heat. The produced electricity is selectively routed to power the traction motors of the freight train. Alternatively, the electricity may be directed to a local or regional power grid, as described below. The water by-product of the electrochemical reaction and fuel cell is directed to the water storage tank for subsequent use in hydro-electrolysis.

The above-described fuel cell unit 40, representing a preferred and practical embodiment in accordance with a best mode of the invention, is modeled after the fuel cell power plant of the space shuttle, the details of which can be found in the space shuttle reference manual at the NASA Kennedy Space Center Internet Website. The individual fuel cells are connected in series and in parallel to generate the required voltage and current. The fuel cell unit 40 of the present invention is of a larger scale than that of the space shuttle, probably in the order of 100-200 times the size. Specifically, the fuel cell unit of the present invention may range between 500 cubic feet (e.g., 5 feet×5 feet×20 feet long) to 1,000 cubic feet (e.g., 5 feet×5 feet×40 feet long). A 500 cubic foot fuel cell unit weighs approximately 26,000 pounds with a capacity of 700 kw of continuous power and 1.2 mw of surge output of up to 15 minutes in length. Doubling the size of the fuel cell unit to 1,000 cubic feet proportionately increases the weight and capacity. Specifically, a 1,000 cubic foot fuel cell unit weighs approximately 52,000 pounds with a capacity of 1.4 mw of continuous power and 2.4 mw of surge output of up to 15 minutes in length.

In the preferred embodiment, the hydro-electrolysis unit 30 is of similar capacity as the fuel cell 40. These two units, along with the water storage tank 20, pumps, AC/DC invertors 16, low pressure compressors, and associated control electronics 112 are easily configured to fit on a single dedicated HPC rail car. Alternatively, the HPC unit 12 can be built on a locomotive chassis, with the diesel fuel tanks, diesel engine 102, generator/alternator set 104, and associated support systems being replaced by the hydro-electrolysis unit 30, fuel cell unit 40, low pressure compressors, and associated electronics.

Operation of the HPC unit 12 for electric energy storage and regeneration is controlled automatically from the lead locomotive. The engineer is provided with controls 112 for selecting the thresholds for dynamic (regenerative) braking, the electrolysis of water, which tank cars and in what order would receive the gas, and to what level. Conversely, when additional power is needed, the engineer is able to set the thresholds for HPC power generation, with control over which tank cars (and tanks) are to supply the fuel cell unit 40.

There are a number of different economic and environmental aspects to using different regeneration, storage, and fuel cell generation strategies or programs. For example, diesel fuel may be very expensive in one area and cheaper in another. The HPC system 10 of the present invention enables a freight train to maximize its range so that diesel may be purchased at the cheapest location. From an environmental standpoint, the HPC system 10 can be used to minimize hydrocarbon emissions, particularly in areas with pollution problems. Diesel locomotive engines are being subjected to increasingly stringent pollution emissions standards, and the HPC system of the present invention represents the most capital and cost-effective means of significantly reducing diesel-electric locomotive emissions. For example, the Los Angeles basin has very high levels of air pollution. Freight trains running east and west routes out of Los Angeles use the Cajon Pass, which is a very significant elevation change. Westbound trains equipped with the HPC system 10 could generate and store large amounts of oxygen and hydrogen, which could then be transferred to local freight trains. This would allow any train operating in the Los Angeles basin to generate most or even all of its electricity via the HPC system rather than using the diesel engine, thereby significantly reducing hydrocarbon emissions with no loss of economic efficiency. Accordingly, use of the HPC system 10 of the present invention to charge oxygen and hydrogen tank cars enables a diesel-electric locomotive to be converted into an electric locomotive. This flexibility allows local passenger trains to operate without using their diesel engines, thereby eliminating both air pollution and the associated noise levels. This electric-only operations mode, using the HPC system 10, also allows individual diesel locomotive engines to be left off until needed for long upgrades, eliminating the fuel consumption and pollution associated with extended idling or light duty operations.

While the latest EMD SD90MAC and GEAC6000 locomotives currently have the greatest dynamic (regenerative) braking capacity, it is both technically feasible and economically viable to add this capacity to older locomotives equipped with the HPC system 10 of the present invention. Previously, it made no sense to install traction motors with greater power ratings than the installed diesel engine because the conventional diesel-electric locomotive can only use the power that it generates. However, the storage and regenerating capacity of the HPC system 10 now makes it logical to install the largest traction motors that will fit in the existing truck design. Specifically, installing larger traction motors on older 2,000-3,000 horsepower locomotives provides three major benefits. First, it maximizes the amount of dynamic (regenerated) braking power available, minimizing the wear and tear on the locomotive's and train's pneumatic friction brakes. Second, use of larger traction motors maximizes the amount of regenerative power available for the HPC unit 12. Third, the additional power available from the HPC unit 10 allows the locomotive to greatly exceed the rated tractive power of the installed diesel (when attached to a charged HPC). Moreover, rebuilding older 2,000-3,000 horsepower locomotives with larger traction motors (i.e., those used on 4,000-6,000 horsepower locomotives) is significantly more cost-effective than buying new 4,000-6,000 horsepower locomotives. And, since the new 4,000-6,000 horsepower units are displacing older 2-3 horsepower units on a 2:3 or even 1:2 basis, there are plenty of older units available for conversion and upgrading.

An interesting alternative use of the power generated by the HPC system 10 is the ability to provide very large amounts of pollution-free electricity to a local or regional power grid. For instance, instead of using regeneration to boost the energy efficiency of trains, static HPC units 12 can instead be connected to the local or regional power grid. The fuel supply for these HPC units 12 can be obtained by swapping empty HPC tank cars for full ones, or by running HPC modified locomotives as needed to supply the land grid and/or to recharge the HPC tank cars. The advantage of this “dual fuel” option is that the combination of locomotive and HPC system generated power creates much greater flexibility when managing short and long term power loads. Locomotives equipped with the HPC system 10 represent one type of capacity, with limited reserves, while HPC units 12 have the ability to respond quickly to loads that significantly exceed their rated continuous output for short periods of time. To put it another way, use of static HPC units 12 represents an inexpensive power reserve that is available when and where needed, as compared to installation of additional power plants that take years to build due to regulatory considerations. Moreover, if there is a major local or regional power shortage due to a natural disaster (e.g., heat waves, earthquakes, hurricanes, etc.), the HPC units 12 can be quickly transported to the specific area in need. Once there, they can economically supply large amounts of power for the short or long term, and they can be quickly deployed if necessary.

While the instant invention has been shown and described in accordance with practical and preferred embodiments thereof, it is recognized that departures from the instant disclosure are contemplated within the spirit and scope of the invention as defined in the following claims and interpreted under the doctrine of equivalents.

What is claimed is:

1. An electric energy storage and regeneration system comprising:
a prime mover including:
an engine for powering movement of the prime mover;
brake means for slowing and stopping the prime mover;
means for generating electricity from energy used to slow the prime mover during operation of said brake means; a hydro power cell unit including:
water storage means for containing a supply of water;
a hydro-electrolysis unit for converting electric energy into hydrogen gas and oxygen gas using the electricity generated by said electricity generating means of the prime mover and water from said supply water;
a fuel cell unit including at least one fuel cell structured and disposed for generating electricity from the energy of the hydrogen gas and oxygen gas; and
means for separately storing the hydrogen gas and oxygen gas created by said hydro-electrolysis unit for subsequent delivery to said fuel cell unit.

2. The system as recited in claim 1 wherein said prime mover is a diesel-electric locomotive.

3. The system as recited in claim 2 wherein said brake means includes dynamic brakes and friction brakes.

4. The system as recited in claim 3 wherein the dynamic brakes are traction motors, and further wherein said traction motors define said electricity generating means.

5. The system as recited in claim 1 wherein said fuel cell unit comprises a plurality of fuel cells.

6. The system as recited in claim 5 further comprising compressor means for compressing the hydrogen gas and oxygen gas in said separate storing means.

7. The system as recited in claim 6 wherein said separate storing means for the hydrogen gas and the oxygen gas includes a plurality of insulated gas storage tanks.

8. The system as recited in claim 7 further comprising cooling means for cooling the hydrogen gas and the oxygen gas for storage in the plurality of insulated gas storage tanks.

9. The system as recited in claim 8 wherein said hydro power cell unit further comprises an oxygen concentrator unit for generating oxygen gas to supplement the oxygen gas produced by said hydro-electrolysis unit.

10. The system as recited in claim 9 wherein said hydro power cell unit and said plurality of insulated storage tanks are contained on one or more train cars pulled by one or more diesel-electric locomotives, and wherein said one or more diesel-electric locomotives define said prime mover.

11. The system as recited in claim 10 wherein the electricity generated by said fuel cell unit is directed to the one or more diesel-electric locomotives for powering traction motors to move the diesel-electric locomotives and a plurality of train cars connected thereto.

12. The system as recited in claim 10 wherein the electricity generated by said fuel cell unit is directed to a local power grid.

13. The system as recited in claim 10 further comprising control means for selectively controlling operation of said hydro power cell unit.

14. A hydro power cell system for storing and regenerating electric energy generated by friction and dynamic brakes of one or more diesel-electric locomotives and a plurality of train cars connected thereto, said system comprising:
water storage means for containing a supply of water;
a hydro-electrolysis unit for converting electric energy into hydrogen gas and oxygen gas using the electric energy generated by the brakes of the train and the locomotive and water from said supply water;
a fuel cell unit including at least one fuel cell structured and disposed for regenerating electricity from the energy of the hydrogen gas and the oxygen gas; and
means for separately storing the hydrogen gas and the oxygen gas created by said hydro-electrolysis unit for subsequent delivery to said fuel cell unit.

15. The system as recited in claim 14 wherein said fuel cell unit comprises a plurality of fuel cells.

16. The system as recited in claim 15 further comprising compressor means for compressing the hydrogen gas and the oxygen gas in said separate storing means.

17. The system as recited in claim 16 wherein said separate storing means for the hydrogen gas and the oxygen gas includes a plurality of insulated gas storage tanks.

18. The system as recited in claim 17 further comprising cooling means for cooling the hydrogen gas and the oxygen gas for storage in the plurality of insulated gas storage tanks.

19. The system as recited in claim 18 further comprising an oxygen concentrator unit for generating oxygen gas to supplement the oxygen gas produced by said hydro-electrolysis unit.

20. The system as recited in claim 19 further comprising means for directing said electricity regenerated by said fuel cell unit to the one or more diesel-electric locomotives for providing electric power to move the one or more diesel-electric locomotives and the plurality of train cars connected thereto.

21. The system as recited in claim 19 further comprising means for directing the electricity regenerated by said fuel cell unit to a local power grid.
